(19) United States
(12) Patent Application Publication
(10) Pub. No.: US 2006/0254027 A1
(43) Pub. Date: Nov. 16, 2006

(54) Hinge

(75) Inventors: Sheng-Nan Lu, Shulin City (TW); Jia-Hao Hsu, Shulin City (TW)

Correspondence Address: Thomas E. Sisson;Jackson Walker, LLP, Suite 2100, 112 E. Pecan, San Antonio, TX, 78205, US

(73) Assignee: Shin Zu Shing Co., Ltd.

(21) Appl. No.: 11/386,863

(22) Filed: Mar. 22, 2006

(30) Foreign Application Priority Data
May 11, 2005 (TW) 094207601

(51) Int. Cl. E05D 11/08

(52) U.S. Cl. 16/342

(57) ABSTRACT

A hinge has a hollow sleeve and a shaft. The sleeve has a first portion and a second portion respectively formed in a first end of the sleeve, and a first fastener formed in a second end of the sleeve. The shaft has a head formed in a first end of the shaft and a second fastener formed in a second end of the shaft. The first fastener is mounted securely in a chassis of a device and the second fastener is mounted securely in a cover of the device. The head is rotated relative to the sleeve when the cover is rotated relative to the chassis. With the friction between the sleeve and the head, the cover can be positioned at any angle as desired relative to the chassis of the device.

### BACKGROUND OF THE INVENTION

1. Field of the Invention

The present invention relates to a hinge, and more particularly to a hinge that can position a cover of a device on a chassis of the device stably.

2. Description of the Related Art

With reference to FIGS. 4 and 5, a conventional hinge comprises a sleeve (50) and a shaft (60). The sleeve (50) has an open end (51) defined in a first end of the sleeve (50) and a gap (52) defined in a side of the sleeve (50) and axially extending from the first end to a second end of the sleeve (50). A first fastener (53) is horizontally formed in the second end of the sleeve (50). The shaft (60) has a head (60) formed in a first end of the shaft (60) and a second fastener (62) horizontally formed in a second end of the shaft (60). An outer diameter of the head (61) is a slightly bigger than an inner diameter of the open end (51) of the sleeve (50) so that the sleeve (50) is expanded when the head (61) is inserted into the open end (51). Therefore, the head (61) is pressed by the sleeve (50). The first fastener (53) is mounted securely on a chassis of a device, and the second fastener (62) is mounted securely on a cover of the device so that the head (61) is rotated relative to the sleeve (50) when the cover is rotated relative to the chassis. With the friction between the sleeve (50) and the head (61), the cover can be positioned at any angle as desired relative to the chassis.

However, when the head (61) is inserted into the sleeve (50) and rotates relative to the sleeve (50), the sleeve (50) is easy to distort because the gap (52) is chafed against the head (61). Hence, the friction between the sleeve (50) and the head (61) is decreased so that the cover is difficult to position at any angle as desired relative to the chassis of the device.

Therefore, the invention provides a hinge to mitigate or obviate the aforementioned problems.

### SUMMARY OF THE INVENTION

The main objective of the present invention is to provide a hinge that can position a cover of a device on a chassis of the device stably.

Other objectives, advantages and novel features of the invention will become more apparent from the following detailed description when taken in conjunction with the accompanying drawings.

### BRIEF DESCRIPTION OF THF DRAWINGS

FIG. 1 is a perspective view of a hinge in accordance with the present invention;

FIG. 2 is an exploded perspective view of the hinge in FIG. 1;

FIG. 3 is a perspective view of the hinge in FIG. 1 in usage;

FIG. 4 is a perspective view of a conventional hinge in accordance with the prior art; and

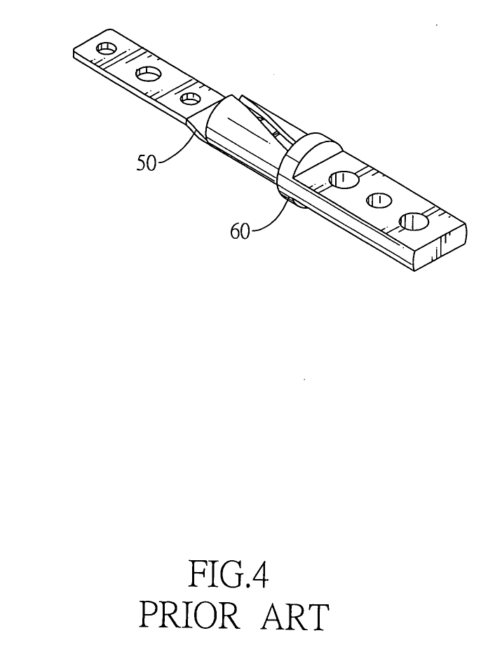

FIG. 5 is an exploded perspective view of the conventional hinge in FIG. 4.

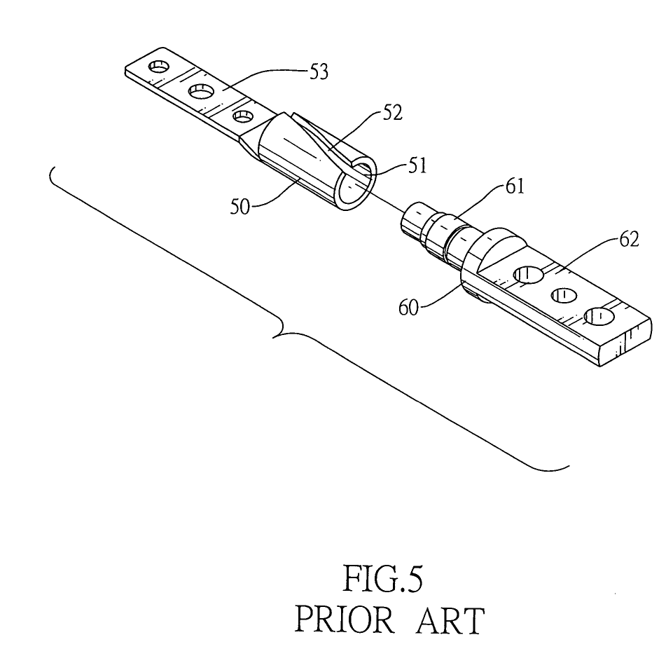

### DETAILED DESCRIPTION OF THE PREFERRED EMBODIMENT

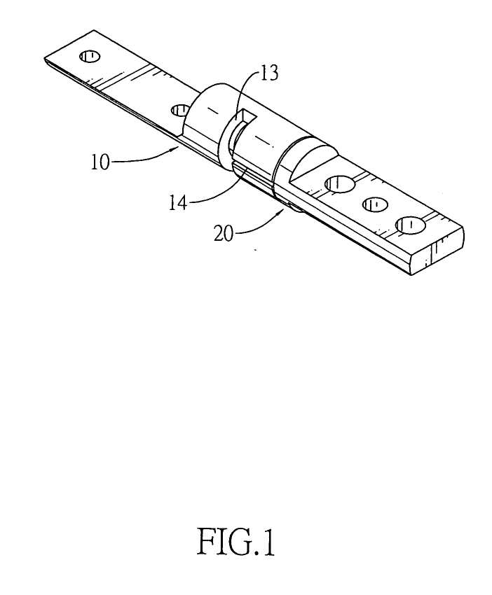

With reference to FIG. 1, a hinge comprises a hollow sleeve (10) and a shaft (20).

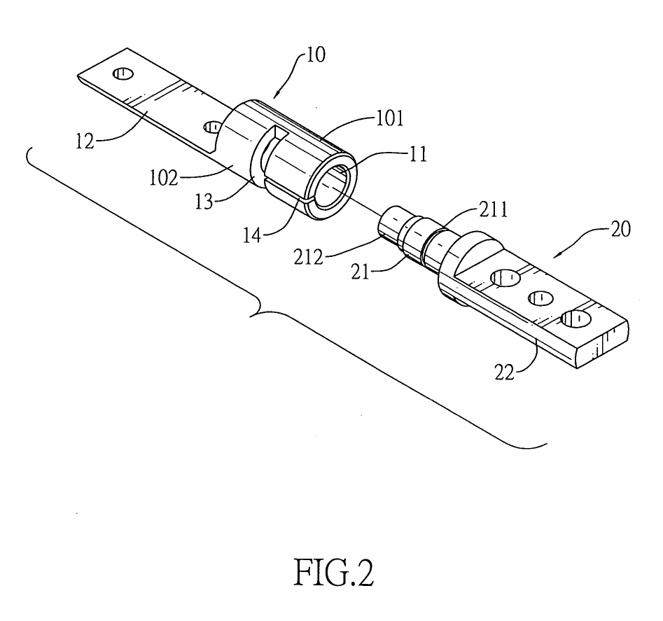

With further reference to FIG. 2, the sleeve (10) has an open end (11) defined in a first end of the sleeve (10) and a first fastener (12) formed on a second end of the sleeve (10). A first portion (101) is formed in the first end of the sleeve (10) and is adjacent to the open end (11). A second portion (102) is formed in a middle portion of the sleeve (10). A gap (13) is radially defined in a side of the sleeve (10) and is formed between the first portion (101) and the second portion (102). A slot (14) is axially defined in the first portion (101) to allow the first portion (101) being expanded and may communicate with the gap (13).

The shaft (20) has a head (21) formed in a first end of the shaft (20) and a free end (212) extending axially out of head (21). A second fastener (22) is formed in a second end of the shaft (20), and an annular notch (211) is defined around the head (21). The sleeve (10) is expanded via the slot (14) and clamps the head (21) when the head (21) is inserted into the open end (11) of the sleeve (10) and the free end (212) of the shaft (20) engages the second portion (102). Hence, the sleeve (10) is mounted securely around the head (21).

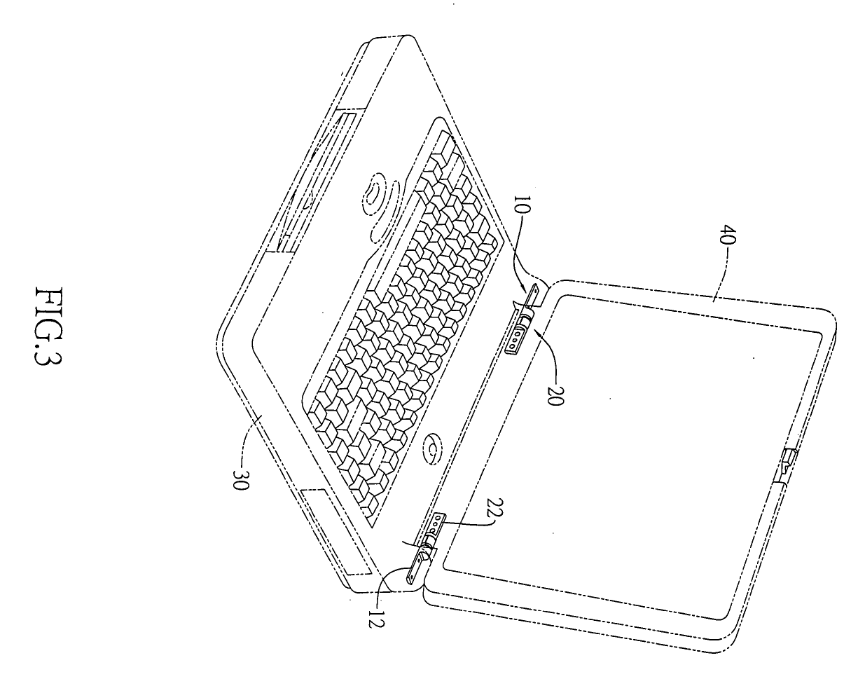

With further reference to FIG. 3, the first fastener (12) is mounted securely a chassis (30) of a device and the second fastener (22) is mounted securely in a cover (40) of the device. The head (21) is rotated relative to the sleeve (10) when the cover (40) is pivoted relative to the chassis (30). With the friction between the sleeve (10) and the head (21), the cover (40) can be positioned at any angle as desired relative to the chassis (30) of the device.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A hinge comprising:
a hollow sleeve having
an open end defined in a first end of the sleeve;
a first fastener formed on a second of the sleeve;
a first portion formed on the sleeve adjacent to the open end; and
a second portion formed on a middle portion of the sleeve;
a gap radially defined in the sleeve between the first and the second portion; and
a slot longitudinally defined in the first portion thereof; and
a shaft rotatably inserted into the sleeve and having
a head formed in a first end of the shaft, inserted into and clamped by the first portion of the sleeve and having
a free end extending axially out of the head and rotatably engaging the second portion of the sleeve; and
a second fastener formed in a second end of the shaft.

2. The hinge as claimed in claim 1, wherein an annular notch is radially defined around the head.
